(19) United States
(12) Patent Application Publication
(10) Pub. No.: US 2025/0349308 A1
(43) Pub. Date: Nov. 13, 2025

(54) SPEECH ENHANCEMENT DEVICE AND METHOD

(71) Applicant: REALTEK SEMICONDUCTOR CORPORATION, HSINCHU (TW)

(72) Inventor: YING-YING CHAO, HSINCHU (CN)

(21) Appl. No.: 19/184,005

(22) Filed: Apr. 21, 2025

(30) Foreign Application Priority Data
May 9, 2024 (TW) 113117231

(51) Int. Cl. G10L 21/007; G10L 25/15

(52) U.S. Cl. CPC G10L 21/007; G10L 25/15

(57) ABSTRACT

The present application discloses a speech enhancement device. The speech enhancement device includes an audio input circuit and a processor. The audio input circuit is configured to convert an audio input signal to a first audio data. The processor is configured to: generate a plurality of audio frames according to the first audio data; perform formant analysis on the audio frames to determine whether to combine adjacent audio frames of the audio frames into an audio segment; apply gain processing to the audio segment including the combined audio frames; and combine the audio segment and one or more uncombined audio frames of the audio frames into a second audio data.

### CROSS-REFERENCE TO RELATED APPLICATIONS

This application claims priority of Taiwan application No. 113117231 filed on May 9, 2024, which is incorporated by reference in its entirety.

### TECHNICAL FIELD

The present disclosure relates to speech enhancement device and method, and more particularly, to device and method that enhance speech based on formant detection.

### BACKGROUND

Nowadays, electronic products usually use techniques such as volume enhancement, noise reduction or echo cancellation to improve speech intelligibility, and such techniques mainly make use of the difference between the noise energy and the speech energy characteristics to separate the two to achieve the intended purpose. However, in some cases of hearing loss, the loss of sensitivity is in specific frequency bands, with some people losing hearing only in high frequency sounds, some people losing hearing only in a few individual frequencies, and some people not only losing sensitivity to sounds of specific frequencies, but the two sounds in close proximity need to have a greater difference in loudness in order to be audibly discerned.

Therefore, the speech enhancement device and method are desired to improve speech intelligibility.

### SUMMARY OF THE INVENTION

The present application discloses a speech enhancement device. The speech enhancement device includes an audio input circuit and a processor. The audio input circuit is configured to convert an audio input signal to first audio data. The processor is configured to generate a plurality of audio frames according to the first audio data, perform formant analysis on the audio frames to determine whether to combine adjacent audio frames of the audio frames into an audio segment, apply gain processing to the audio segment comprising the combined audio frames, and combine the audio segment and one or more uncombined audio frames of the audio frames into second audio data.

Furthermore, the present application discloses a speech enhancement method. The speech enhancement method includes: converting an audio input signal to a first audio data; generating a plurality of audio frames according to the first audio data; performing formant analysis on the audio frames to determine whether to combine adjacent audio frames of the audio frames into an audio segment; applying gain processing to the audio segment comprising the combined audio frames; and combining the audio segment and one or more uncombined audio frames of the audio frames into a second audio data.

In summary, the speech provided by the speech enhancement device and method has enhanced formants, making the provided speech more unique. Therefore, speech intelligibility can be improved, which in turn enhances speech recognition.

### BRIEF DESCRIPTION OF THE DRAWINGS

Aspects of the present disclosure are best understood from the following detailed description when read with the accompanying drawings. It is noted that, in accordance with the common practice in the industry, various features are not drawn to scale. In fact, the dimensions of various features may be arbitrarily increased or reduced for clarity of discussion.

FIG. 1 is an electronic device according to one embodiment of the present disclosure.

FIG. 2 is a schematic diagram illustrating the formants of the speech according to one embodiment of the present disclosure.

FIG. 3 illustrates a speech enhancement method according to one embodiment of the present disclosure.

FIGS. 4A and 4B are schematic diagrams illustrating the sampling of the audio data and generation of a plurality of audio frames.

FIG. 5 is a schematic diagram illustrating performing windowing, linear prediction coding and formant analysis on the audio frame.

FIG. 6 is a table showing the formants of an audio segment formed by a plurality of audio frames.

FIG. 7A is a flow chart illustrating applying gain processing to an audio segment of FIG. 6 according to one embodiment of the present disclosure.

FIG. 7B is a schematic diagram illustrating the signals at each stage shown in the flow chart of FIG. 7A.

FIG. 8 is a schematic diagram illustrating the combination of the audio segment and uncombined audio frame into an audio data.

### DETAILED DESCRIPTION

There are various types of hearing loss, and the present disclosure provides a speech enhancement device and a related method for enhancing the formant frequencies in acoustics related to the human body's speech production process. Since the formant frequencies vary from person to person due to the different physiological structure of each person, the enhancement of a specific frequency is used to obtain a clearer speech recognition.

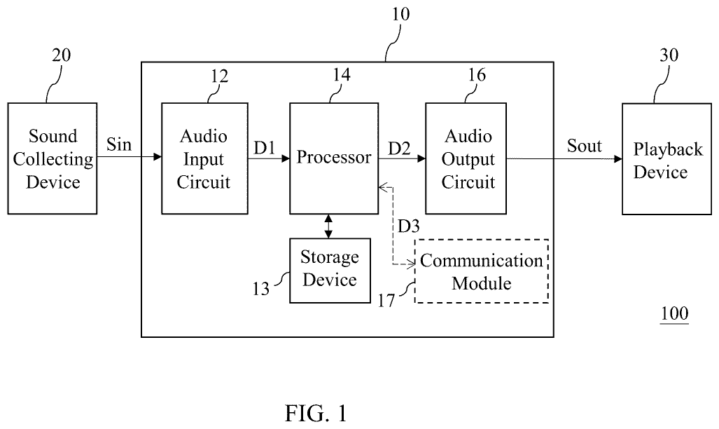

FIG. 1 illustrates an electronic device 100 according to one embodiment of the present disclosure. The electronic device 100 includes a speech enhancement device 10, a sound collecting device 20 and a playback device 30. The sound collecting device 20 is configured to receive the speech from the surroundings and provide an audio input signal Sin to the speech enhancement device 10. The speech enhancement device 10 is configured to amplify the speech part of the audio input signal Sin and provide an audio output signal Sout with the amplified speech to the playback device 30 for playback. In some embodiments, the sound collecting device 20 may be a microphone, and the playback device 30 may be a speaker. In some embodiments, the speech enhancement device 10 is implemented in an integrated circuit (IC). In some embodiments, the electronic device 100 can be applied in devices for receiving and playing audio, such as hearing aids, portable electronic devices, home appliances and so on.

The speech enhancement device 10 includes an audio input circuit 12, a storage device 13, a processor 14 and an audio output circuit 16. The audio input circuit 12 is configured to generate an audio data D1 according to the audio input signal Sin. The audio input signal Sin is an analog signal, and the audio data D1 is a digital signal. In some embodiments, the audio input circuit 12 includes an analog-to-digital converter (ADC), noise suppressor and so on. After receiving the audio data D1, the processor 14 is configured to amplify the speech characteristics of the audio data D1 (such as, the formant), to generate an audio data D2. The audio output circuit 16 is configured to generate the audio output signal Sout according to the audio data D2. In some embodiments, the audio output signal Sout is an analog signal, and the audio data D2 is a digital signal. In some embodiments, the audio output circuit 16 includes a digital-to-analog converter (DAC), amplifier and so on.

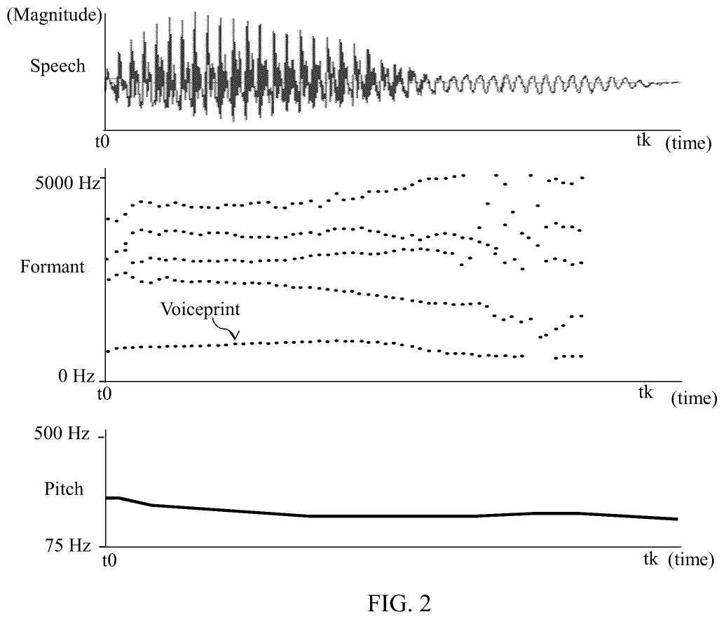

Generally speaking, speech is a series of sound waves, and most of them are below 5000 Hz. The sound source begins with the vibration of the vocal cords, and the shape of the vocal cords and the muscles that control the vibration of the vocal cords affect the frequency of the vocal cords, i.e., the pitch, also known as the F0. When the sound source passes through the vocal tract, the airflow of speech and the structure of the vocal cords cause resonance, making certain frequency points have a significant intensity. These frequency points are called formants, which determine the timbre. The lowest formant is called F1, the second lowest is F2, and so on. Since each person's physiology is different, the formants measured for the same sound will vary from person to person. Speech usually consists of four or five stable formants with strong amplitudes. In addition, connecting the frequencies of the formants at each time point forms multiple formant curves (i.e., voiceprints), as shown in FIG. 2.

In the speech enhancement device 10 of FIG. 1, the processor 14 may execute an audio processing program to detect the formant in the speech from the audio data D1 and enhance it to provide the audio data D2. In addition, the processor 14 can be combined with the storage device 13 to execute the audio processing program. In some embodiments, the processor 14 is a digital signal processor (DSP) or central processing unit (CPU). In some embodiments, the storage device 13 may include a memory or a buffer.

In some embodiments, the speech enhancement device 10 further includes a communication module 17. The communication module 17 is configured to connect to other electronic devices (such as, televisions, Bluetooth speakers, etc.) in a wired or wireless manner. In some embodiments, the processor 14 may encode the audio data D2 according to a known audio coding format (such as a pulse code modulation (PCM) format) and provide the audio data D3 to the communication module 17 for transmission of the audio data D3 to the other electronic device for playback. In some embodiments, the processor 14 may receive the audio data D3 from the other electronic device through the communication module 17 and decode it. Next, the processor 14 may detect the formants from the decoded audio data and enhance the speech based on the detected formants to provide the audio data D2 to the audio output circuit 16.

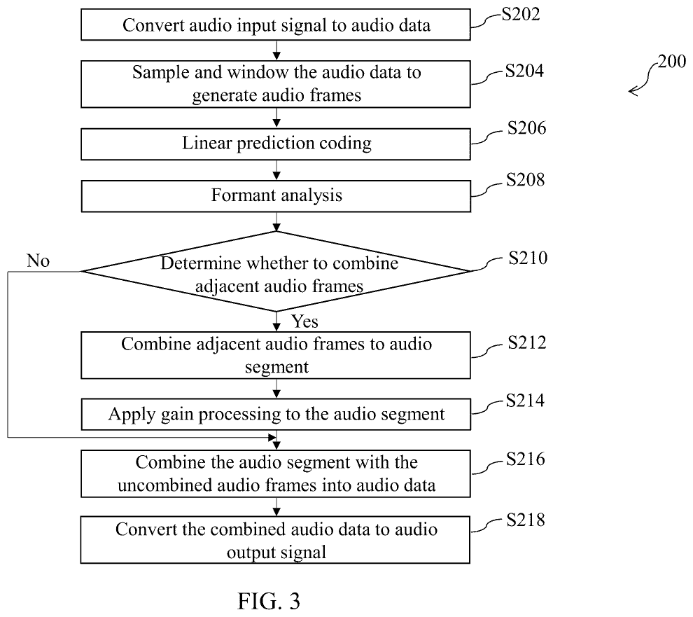

FIG. 3 shows a speech enhancement method 200 according to one embodiment of the present disclosure. The speech enhancement method 200 can be executed by using the speech enhancement device 10 of FIG. 1. In some embodiments, the processor 14 of FIG. 1 may be implemented by using any suitable form, including hardware circuitry, software, firmware, or any combination thereof. In some embodiments, at least one portion of the processor 14 may optionally be implemented as computer software running on one or more image processors, data processors, and/or digital signal processors, or configurable module elements (e.g., FPGAs).

Reference is made to both FIG. 1 and FIG. 3. In operation S202, the audio input circuit 12 is configured to convert the audio input signal Sin to the audio data D1 and provide the audio data D1 to the processor 14.

In operation S204, the processor 14 is configured to sample and window the audio data D1 to generate continuous audio frames Fr, that is, perform a window function on the audio frames Fr. In some embodiments, two adjacent audio frames Fr may partially overlap. In some embodiments, the sampling rate of the audio data D1 is determined by the sampling frequency of the audio input circuit 12. In addition, the sampling rate and window function are stored in the storage device 13. In some embodiments, the processor 14 is configured to decode, sample, and perform widowing on the audio data D3 from the communication module 17 to generate the audio frames Fr.

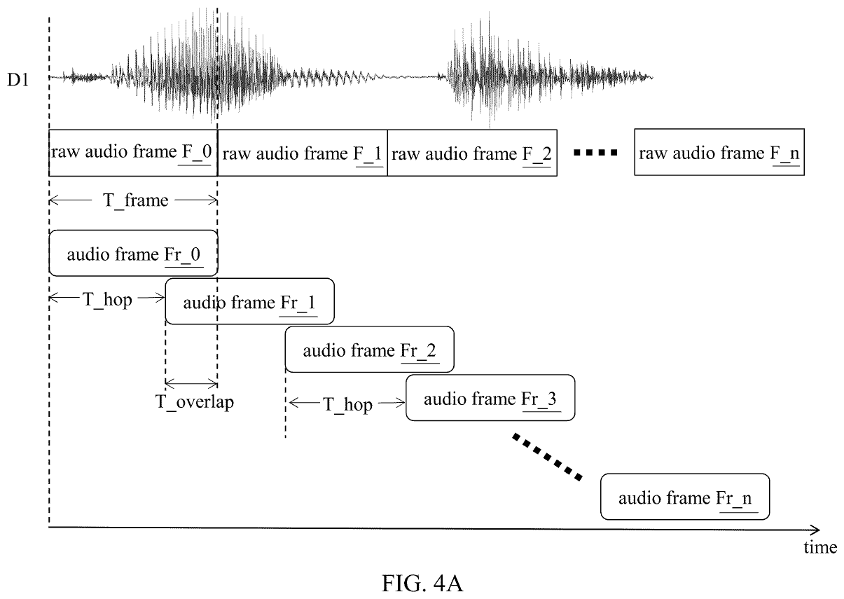

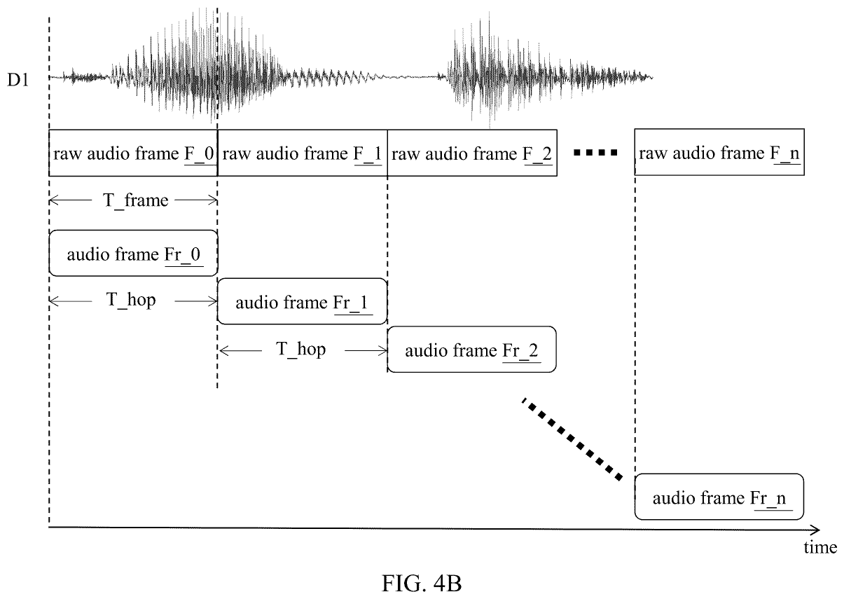

Reference is made to both FIG. 1 and FIG. 4A. FIG. 4A is a schematic diagram illustrating the sampling of the audio data D1 and the generation of audio frames Fr_0 through Fr_n according to one embodiment of the present disclosure. The processor 14 is configured to first sample the audio data D1 to generate the raw audio frames F_0 through F_n. Next, the processor 14 is configured to overlap adjacent raw audio frames to obtain the audio frames Fr_0 through Fr_n. In the embodiment of FIG. 4, the raw audio frames F_0 through F_n and the audio frames Fr_0 through Fr_n have the same audio frame size T_frame, and the audio frames Fr_0 through Fr_n have a frame overlap T_overlap. For example, the audio frame Fr_2 may partially overlap the adjacent previous audio frame Fr_1 and the adjacent subsequent audio frame Fr_3. In some embodiments, the audio frame size T_frame of the audio frames Fr_0 through Fr_n includes 1024 sampling points, and the audio frame overlap T_overlap is 256 sampling points. In addition, the audio frame hop size of the audio frames Fr_0 through Fr_n is T_hop, which represents the starting point distance of two adjacent audio frames Fr, where the audio frame hop size T_hop is equal to the audio frame size T frame minus the audio frame overlap T_overlap. The audio frame size T frame, the audio frame hop size T_hop and the audio frame overlap T_overlap can be stored in the storage device 13. In some other embodiments, two adjacent audio frames Fr do not overlap each other, that is, the audio frame overlap T_overlap is 0 sampling point, so that the audio frame hop size T_hop is the same as the audio frame size T_frame, as shown in FIG. 4B.

Returning to FIG. 3, in operation S206, the processor 14 is configured to perform linear prediction coding (LPC) on each audio frame Fr generated in operation S204 to obtain the formants. In the LPC, the formants are frequency peaks with high energy in the spectrum. In addition, the number of formants is determined by the order of the LPC equation. For the sake of simplicity, the calculation process of LPC is omitted herein.

In operation S208, the processor 14 is configured to analyze the formants of each audio frame Fr to obtain information such as the number, frequency and bandwidth (BW) of the formants, and the like.

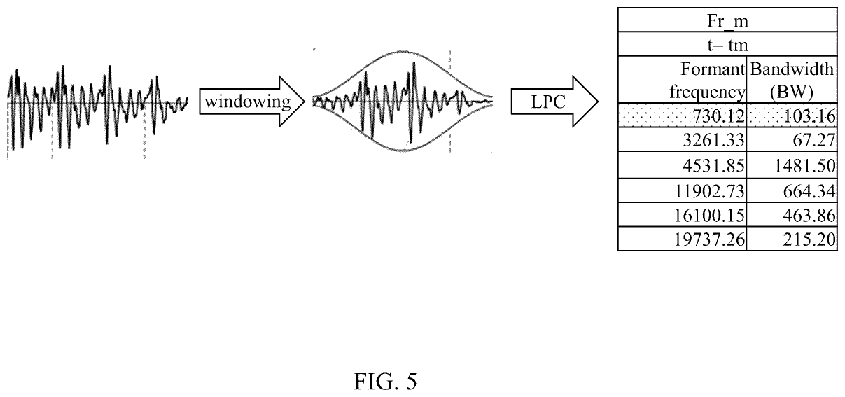

Referring to FIG. 5, FIG. 5 is a schematic diagram illustrating performing windowing, LPC and formant analysis on the audio frame Fr_m. The window function can be a known function such as Gaussian window, Hann window or Hamming window. In the formant analysis, the starting time of the audio frame Fr_m can be obtained as tm. In addition, multiple formants (for example, six) can be obtained after performing LPC on the audio frame Fr_m. Based on the frequencies and bandwidths of the formants, the processor 14 can determine which formants correspond to speech. For example, when the frequency of the formant is greater than 250 Hz and less than 3000 Hz and the bandwidth is less than 600 Hz, the processor 14 is configured to determine that the formant corresponds to speech, that is, it is a valid formant.

Returning back to FIG. 3, in operation S210, according to the results of the analysis of the formants of each audio frame Fr in operation S208, the processor 14 is configured to determine whether to combine the adjacent audio frames Fr. When there is no formant (valid formant) corresponding to speech in one or more audio frames Fr, the processor 14 determines that the one or more audio frames do not need to be combined, and the process proceeds to operation S216. On the contrary, in operation S212, when multiple consecutive audio frames Fr have the valid formants, the processor 14 is configured to decide to combine these audio frames Fr into an audio segment SEG. In addition, the processor 14 is configured to group the valid formants of the audio segment SEG to obtain the average frequency, average bandwidth, etc. of the valid formants of each group.

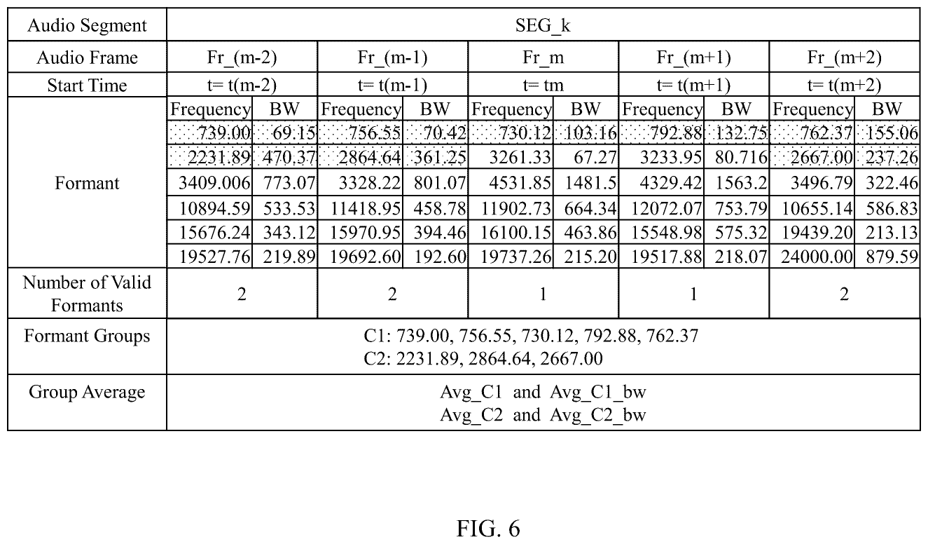

Referring to FIG. 6; FIG. 6 is a table showing the formant information of the audio segment SEG_k formed by the audio frames Fr_(m−2) through Fr_(m+2). In some embodiments, when the numbers of valid formants of N consecutive audio frames Fr are all greater than 0, the first audio frame in the N consecutive audio frames Fr is assigned by the processor 14 as the starting audio frame of the audio segment SEG. In addition, when the numbers of valid formants of the M consecutive audio frames Fr after the starting audio frame are all equal to 0, the audio frame preceding the M consecutive audio frames Fr is assigned by the processor 14 as the end audio frame of the audio segment SEG. In some embodiments, N may equal to M. In some embodiments, N is different from M. In the embodiment of FIG. 6, M and N are set to 3, and the audio segment SEG_k includes five audio frames Fr_(m−2) through Fr_(m+2). In addition, the audio frame Fr_(m−2) is the start audio frame, and the audio frame Fr_(m+2) is the end audio frame. In other words, the numbers of valid formants of the three consecutive audio frames Fr after the audio frame Fr_(m+2) are 0.

As shown in FIG. 6, after obtaining all the audio frames of the audio segment SEG_k, the processor 14 is configured to divide the valid formants of the audio frames Fr_(m−2) through Fr_(m+2) into the groups C1 and C2 according to the maximum number 2 of the valid formants. The group C1 includes the first valid formant of the audio frames Fr_(m−2) through Fr_(m+2), and the group C2 includes the second valid formant of the audio frames Fr_(m−2), Fr_(m−1) and Fr_(m+2). Next, the processor 14 is configured to average the frequencies and bandwidths of each group to respectively obtain the average frequencies Avg_C1 and Avg_C2 and the average bandwidths Avg_C1_bw and Avg_C2_bw of the groups C1 and C2.

Referring again to FIG. 3, in operation S214, the processor 14 is configured to apply gain processing to the audio segment SEG according to the average values of the valid formants of each group obtained in operation S212.

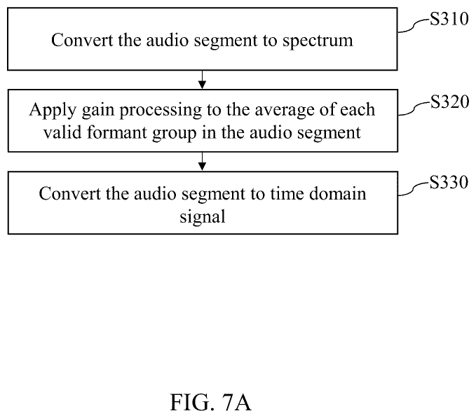

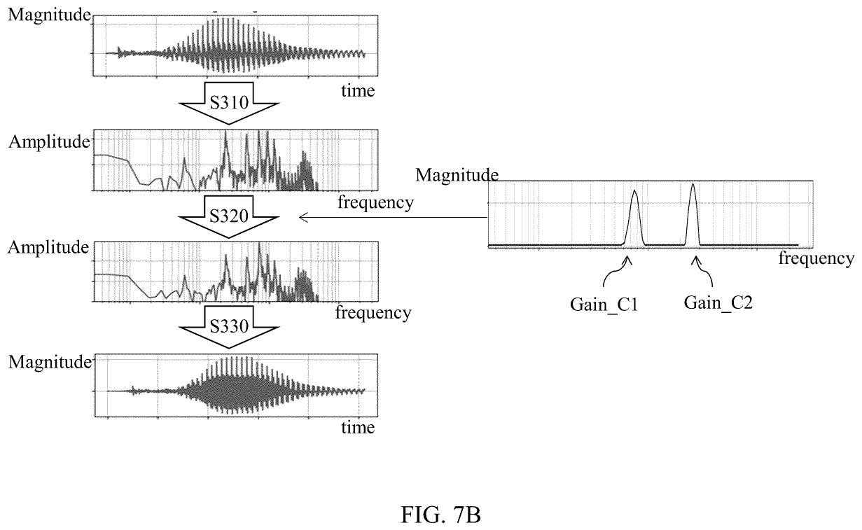

Referring to both FIG. 7A and FIG. 7B, FIG. 7A is a flow chart illustrating applying gain processing to an audio segment SEG_k of FIG. 6 according to one embodiment of the present disclosure, and FIG. 7B is a schematic diagram illustrating the signals at each stage shown in the flow chart of FIG. 7A. First, in operation S310, the processor 14 of FIG. 1 is configured to convert the audio segment SEG_k to the spectrum (e.g., by performing a Fourier transform), that is, to a frequency domain signal. In operation S320, the processor 14 is configured to generate the corresponding gain values Gain_C1 and Gain_C2 according to the average frequencies Avg_C1 and Avg_C2 and the average bandwidths Avg_C1_bw and Avg_C2_bw of the groups C1 and C2, and applies the gain values Gain_C1 and Gain_C2 to the spectrum of the audio segment SEG_k. In operation S330, the processor 14 is configured to convert the audio segment SEG_k to a time domain signal. Thus, in the audio segment SEG_k, the processor 14 is configured to only apply gain processing to the average of the valid formants of groups C1 and C2.

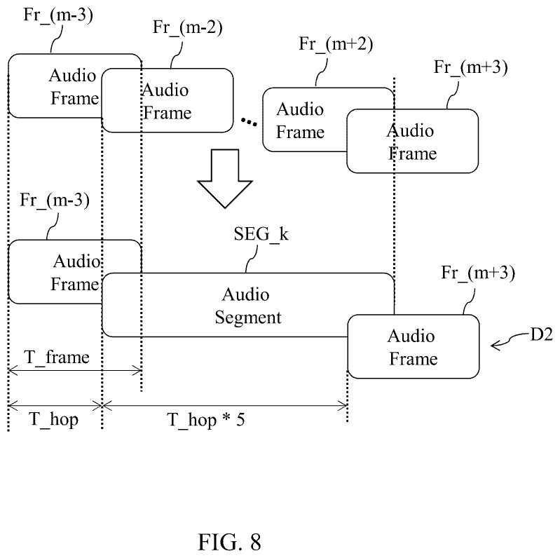

Returning back to FIG. 3, in operation S216, the processor 14 is configured to combine the gained audio segment SEG with the uncombined audio frames Fr into the audio data D2 (e.g., an audio stream). For example, as shown in FIG. 8, the audio segment SEG_k is combined with the audio frames Fr_(m−3) and Fr_(m+3) to form the audio data D2. As previously described, the uncombined audio frames (e.g., the audio frames Fr_(m−3) and Fr_(m+3)) do not have the formants that correspond to speech. In some embodiments, the processor 14 is configured to provide the audio data D3 to the communication module 17 according to the audio data D2, so as to transmit the audio data D3 to other electronic devices for playback.

In operation S218, the audio output circuit 16 is configured to convert the audio data D2 to the audio output signal Sout, and provide the audio output signal Sout to the playback device 30.

According to the present speech enhancement method 200, the electronic device 100 is configured to detect the formants in speech and enhance them to enhance vowel characteristics, making the enhanced speech more unique. As a result, speech intelligibility can be improved, which in turn enhances speech recognition. For example, when the electronic device 100 is a hearing aid, the speech of other people around the user (e.g., an elderly person or a hearing impaired person) wearing the hearing aid may become clearer through the hearing aid, making it easier for the wearer to recognize the content of the speech. In addition, the speech enhancement method 200 may be implemented in an electronic product capable of performing speech recognition, so that the electronic product can more accurately and quickly recognize the content of the incoming speech and perform corresponding operations.

Although the preferred embodiments of the present disclosure have been described above, they are not used to limit the present disclosure, and a person having ordinary skill in the art will be able to make certain changes and modifications without departing from the spirit and scope of the disclosure, and thus, the protection scope of the present disclosure is defined by the annexed claims.

What is claimed is:

1. A speech enhancement device, comprising:
an audio input circuit, configured to convert an audio input signal to first audio data; and
a processor, configured to:
generate a plurality of audio frames according to the first audio data;
perform formant analysis on the audio frames to determine whether to combine adjacent audio frames of the audio frames into an audio segment;
apply gain processing to the audio segment comprising the combined audio frames; and
combine the audio segment and one or more uncombined audio frames of the audio frames into second audio data.

2. The speech enhancement device of claim 1, wherein the processor is configured to perform the formant analysis on each of the audio frames to obtain a number of formants in each of the audio frames.

3. The speech enhancement device of claim 2, wherein the formants of each of the audio frames is greater than 250 Hz and less than 3000 Hz.

4. The speech enhancement device of claim 2, wherein when the number of formants in each of N consecutive audio frames of the audio frames is greater than 0, a first audio frame of the N consecutive audio frames is a start audio frame of the audio segment.

5. The speech enhancement device of claim 4, wherein when the number of formants in each of M consecutive audio frames of the audio frames after the start audio frame is equal to 0, the audio frame preceding the M consecutive audio frames is an end audio frame of the audio segment.

6. The speech enhancement device of claim 1, wherein the processor is configured to divide a plurality of formants of the audio frames of the audio segment into a plurality of groups according to a maximum number of formants across the audio frames, and to obtain an average frequency and an average bandwidth of the formants for each of the groups.

7. The speech enhancement device of claim 6, wherein the processor is configured to apply the gain processing to the audio segment according to the average frequencies and the average bandwidths of the groups.

8. The speech enhancement device of claim 1, wherein the processor is configured to sample and window the first audio data to generate the audio frames.

9. The speech enhancement device of claim 8, wherein each of the audio frames is partially overlapped with an adjacent preceding audio frame and an adjacent subsequent audio frame.

10. The speech enhancement device of claim 1, further comprising an audio output circuit, configured to convert the second audio data to an audio output signal.

11. The speech enhancement device of claim 10, wherein the audio input circuit comprises an analog-to-digital converter, and the audio output circuit comprises a digital-to-analog converter, wherein the audio input signal is provided from a sound collecting device, and the audio output signal is provided to a playback device.

12. The speech enhancement device of claim 1, further comprising a communication module, configured to transmit the second audio data to an electronic device in a wired or wireless manner.

13. A speech enhancement method, comprising:
converting an audio input signal to a first audio data;
generating a plurality of audio frames according to the first audio data;
performing formant analysis on the audio frames to determine whether to combine adjacent audio frames of the audio frames into an audio segment;
applying gain processing to the audio segment comprising the combined audio frames; and
combining the audio segment and one or more uncombined audio frames of the audio frames into a second audio data.

14. The speech enhancement method of claim 13, wherein the audio frames of the audio segment comprises one or more formants that are greater than 250 Hz and less than 3000 Hz.

15. The speech enhancement method of claim 13, wherein performing the formant analysis on the audio frames to determine whether to combine the adjacent audio frames of the audio frames into the audio segment further comprises:
performing the formant analysis on each of the audio frames to obtain a number of formants in each of the audio frames;
when the number of formants in each of N consecutive audio frames of the audio frames is greater than 0, assigning a first audio frame of the N consecutive audio frames as a start audio frame of the audio segment; and
when the number of formants in each of M consecutive audio frames of the audio frames after the start audio frame is equal to 0, assigning the audio frame preceding the M consecutive audio frames as an end audio frame of the audio segment.

16. The speech enhancement method of claim 13, further comprising:
dividing the formants of the audio frames into a plurality of groups according to a maximum number of formants across the audio frames of the audio segment; and
obtaining an average frequency and an average bandwidth of the formants for each of the groups.

17. The speech enhancement method of claim 16, wherein applying the gain processing to the audio segment comprising the combined audio frames further comprises:
obtaining a plurality of gain values according to the average frequencies and the average bandwidths of the groups; and
applying the gain values on a spectrum of the audio segment.

18. The speech enhancement method of claim 13, wherein generating the audio frames according to the first audio data further comprises:
sampling the first audio data; and
windowing the sampled first audio data to generate the audio frames.

19. The speech enhancement method of claim 18, wherein each of the audio frames is partially overlapped with an adjacent preceding audio frame and an adjacent subsequent audio frame.

20. The speech enhancement method of claim 13, further comprising:
transmitting the second audio data to an electronic device in a wired or wireless manner through a communication module.
